(19) United States
(12) Patent Application Publication
(10) Pub. No.: US 2005/0262361 A1
(43) Pub. Date: Nov. 24, 2005

(54) System and method for magnetic storage disposal

(75) Inventor: Robert Harwell Thibadeau, Pittsburgh, PA (US)

Correspondence Address: SEAGATE TECHNOLOGY LLC C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Seagate Technology LLC, Scotts Valley, CA (US)

(21) Appl. No.: 10/852,710

(22) Filed: May 24, 2004

(51) Int. Cl. H04L 9/32

(52) U.S. Cl. 713/193

(57) ABSTRACT

A storage system has integrated information security features adapted to interact with a host system. The storage system includes a storage media, controller firmware and a controller. The storage media is adapted to store data. Controller firmware stores a secret. The controller controls data transfers between the host system and the storage media, and is adapted encrypt and decrypt data written to or read from the storage media using an encryption key based on the secret.

### BACKGROUND OF THE INVENTION

The present invention relates to magnetic storage disposal. More particularly, the present invention relates to a method to enable safe disposal of magnetic storage media and/or safe re-purposing of the magnetic storage media.

Many discarded hard drives contain information that is both confidential and recoverable. While a fundamental goal of information security is to design computer systems that prevent unauthorized disclosure of confidential information while the drive is in use, few such information security systems are capable of protecting the data after the drive has been discarded or re-purposed. While industry estimates indicate that a typical hard drive has a life span of approximately five years, it is impossible to know how long any particular disc drive will remain in service.

As individuals and corporations upgrade their systems, hard discs are often retired. In some instances, the drives are destroyed. However, in many cases, the disc drives may be re-purposed. The term “re-purpose” refers to a process of recycling the hard disc which typically involves reformatting the hard disc and “wiping” the disc clean of data. Once the hard disc is recycled, in some instances, the entire computer system including the hard disc is sold for reuse. In other cases, the hard discs are removed from the computer and resold.

It is well-known that hard discs and other magnetic storage media can contain recoverable data even after they have been reformatted and supposedly “wiped” clean. Examples of some disc “cleaning” practices and their relative effectiveness are described in an article by Simon L. Garfinkel and Abhi Shelat (both graduate students at Massuchusetts Institute of Technology) entitled, “Remembrance of Data Passed: A Study of Disk Sanitization Practices”, published by the IEEE Computer Society, January/February 2003 (http://computer.org/security/) pages 17-27.

In general, most techniques that people use to insure information privacy fail when the data storage equipment is sold on the secondary market. For example, the benefits of any operating system-based protections are typically lost when the hard disc is removed from the original computer. When such a disc is installed in another system capable of reading the disc formatting, there is no guarantee that the system will honor any stored access control lists. This particular vulnerability of protected data has been recognized since the 1960s.

While the best way to assure that a drive's data is protected is to physically destroy the drive, such practices are tremendously wasteful. Many companies that are upgrading their systems may wish to extract some value from used machines that are taken out of service. Destroying the machines or the drives eliminates such a possibility.

Conventionally, unless retired drives are physically destroyed, poor information security practices can jeopardize information privacy. Hard discs that have been handled with poor information security practices can pose special and significant problems in maintaining long-term data confidentiality.

Many individuals attempt to sanitize their hard discs by deleting files. However, depending on the particular file system used, the notion of the term “delete” or “erase” may vary. In many cases, deleting files does not remove the data. Instead, the deletion process merely re-writes the metadata that pointed to the file, leaving the disc block that contains the file's contents intact. There are programs such as Norton GoBack™, for example, that was created by Symantec Corporation of Cupertino, Calif., and that can be used to recover erased files.

When a disc drive fails, sometimes the drive is simply removed from the system and discarded. In this instance, the user may not be able to erase the drive prior to discarding the drive. However, a determined individual could recover the discarded drive and send it to a professional data recovery company to retrieve the data from the failed drive. In this instance, even a crashed hard disc may not be safe from a determined individual.

Conventionally, the most common techniques for sanitizing hard discs include degaussing the drive to randomize the magnetic domains, writing over the drives' data with null data, or physically destroying the drive. These three techniques have been adopted by the United States Department of Defense for outside contractors with respect to non-classified information.

“Degaussing” refers to a technique by which the magnetic media is returned to its initial state. Degaussing requires exposing the magnetic medium to an external magnetic field sufficient to change the magnetization direction of all of the domains of the disc. The switching depends both on the magnitude of the magnetic field and on the length of time for which the field is applied. For a typical disc drive media, even small magnetic fields are sufficient to upset the normal operation of the magnetic medium (typically a few gauss at DC, dropping to a few milligauss at 1 MHz).

Coercivity is a property of magnetic material relating to the amount of magnetic field required to reduce the magnetic induction in the material to zero. However, disc media typically have a fairly high coercivity (Coercivity is measured in Oersteds “Oe”, and disc drives typically have a coercivity in excess of 750 Oe), making them difficult to erase. A magnetic force sufficient to fully erase a disc drive, which will generally be successful in randomizing the magnetic domains, may also render drives unusable in the process.

Overwriting the data by filling every addressable block with ASCII Null bytes (zeroes) may not successfully protect the information either. Researchers have asserted that simple overwriting of data without a changing pattern is insufficient to protect data from a determined attacker. Peter Gutmann, for example, in an article entitled “Secure Deletion of Data from Magnetic and Solid-State Memory”, which was first published in the Sixth USENIX Security Symposium Proceedings, San Jose, Calif., Jul. 22-25, 1996, suggests that data overwritten once or twice may be recoverable. According to Gutmann, the write head sets the polarity of most, but not all of the magnetic domains, in part because the write head is unable to write to exactly the same location each time and because the media sensitivity and field strength vary over time and among devices. Thus, when a zero is overwritten with a one, the actual measured value may be about 0.95. When a one is overwritten with a one, the actual value may be about 1.05. While normal disc circuitry will read both values as ones, specialized circuitry may be used to detect such variances and to uncover the underlying layers of data.

Another technique for securing data on a hard disc involves cryptography. Specifically, users can encrypt data that is sent or decrypt it at an intended destination using, for example, a decryption and/or encryption key. A key is a string of bits used widely in cryptography to encrypt and decrypt data, and to perform other mathematical operations as well. Various encryption and corresponding decryption algorithms are commonly used today. The combination of an encryption algorithm and a corresponding decryption algorithm is known as a “cipher”. Given a cipher, a key determines the mapping of the plaintext string (data string to be encrypted) of bits to the ciphertext.

One popular category of ciphers involves “public key” ciphers. In public-key cryptography, the public key is primarily used for encryption but is also used for verification of digital signatures. Public-key cryptography is based on methods involving a public key (a key that is made public to all) and a private key (a key that is not made public).

Using public key ciphers, the functionality of the encrypting and decrypting algorithm is publicly known, but the secret “private key” is used to decrypt or sign data using the known algorithm. The private key is a data value that is factored into operation of the algorithm in such a way that the resulting encrypted data is a function of the key value. The private key may also be used to decrypt the data using the decryption algorithm. When the same key is used to encrypt and to decrypt the data, the key is a “symmetric” cipher.

Conventional techniques for encrypting stored data are typically application specific, meaning that each particular application may store data created by that application in an encrypted format. However, such encryption techniques typically store the key in a file somewhere on the computer, making the key recoverable.

Another conventional technique utilizes data specific to the computer system on which the software is running, combined with information identifying the authorized user, in order to form a key used by the encryption and decryption facilities. An example of such a conventional technique is described in U.S. Pat. No. 6,173,402, which is incorporated herein by reference. Since the system assembles the key dynamically, the data is accessible only if the drive remains in the original computer system. However, such a system theoretically does not allow for users to share a computer without sharing the key and also does not allow for specific components to be replaced. For example, if the data that is specific to the computer system is a characteristic of the hardware, that piece of hardware cannot be replaced without losing access to the data. Conventionally, this deficiency is overcome by allowing the key to be exposed to the user via the display screen. However, the user has to record the key, and subsequent use of the data requires the key to be entered by the user. If the key is entered by the user, a “trojan horse” type virus (a software virus that masquerades as a useful application, but that performs a destructive function instead of or in addition to the function the user expects) designed to record keystrokes and forward the keystrokes to an “intruder” via the Internet may cause the key to be compromised.

File and disc encryption software products exist that run within the host computer. Such disc encryption solutions tend to be low security because the encryption key can be read.

File and disc encryption hardware products also exist. In some cases, the encryption hardware is in the electronics attached to the disc drive, and in others it is in the Advanced Technology Attachment (ATA) interface or the Small Computer System Interface (SCSI) to the drive. However, these solutions provide a singular, inflexible method for key management, and may be dissociated from the drive leaving the drive unusable for normal read/write operations.

### SUMMARY OF THE INVENTION

In one embodiment, a storage system has integrated information security features adapted to interact with a host system. The storage system includes a storage media, controller firmware and a controller. The storage media is adapted to store data. Controller firmware stores a secret. The controller controls data transfers between the host system and the storage media, and is adapted encrypt and decrypt data written to or read from the storage media using an encryption key based on the secret.

In another embodiment, the storage device is adapted to provide integrated encryption security. The storage device includes a storage media and a controller. The storage media is adapted to store data received from a host system. The controller within the storage device is adapted to control data transfers between the host system and the storage media, and to encrypt and decrypt all data written to or read from the storage media using a removable token.

In another embodiment, a method is used to secure data on a storage device, which has a controller and a storage media. The controller is configured to encrypt with a symmetric key all data written to the storage media. The symmetric key is known in plaintext to the controller.

In another embodiment, a storage system has a storage media, a data interface element, and a controller. The data interface element is disposed adjacent to the storage media. The controller interacts with the data interface element to read or write data between the storage media and a host system using an encryption key based on a secret.

In another embodiment, a storage device has a storage media, a data interface element and a controller. The data interface element is disposed adjacent to the storage media. The controller interacts with the data interface element to read or write data between the storage media and a host system using an encryption key based on a removable token.

In another embodiment, a storage device has a storage media, a data interface element and a controller. The data interface element coupled to the storage media. The controller is coupled to the data interface element and interacts with the data interface element to read or write data between the storage media and a host system using an encryption key.

### BRIEF DESCRIPTION OF THE DRAWINGS

FIG. 1 is a perspective view of a disc drive in which the present invention is useful.

FIG. 2 is a simplified block diagram of an embodiment of the present invention having a secret held in a non-volatile store.

FIG. 3 is a simplified block diagram of an embodiment of the present invention wherein the secret is loaded dynamically from a remote location during times of desired use.

FIG. 4 is a simplified block diagram of an embodiment of the present invention wherein an encrypted secret is loaded dynamically as needed and is combined with a locally stored secret to derive an encryption/decryption key.

FIG. 5 is a simplified block diagram of an embodiment of the present invention wherein a secret is in a removable token attached to the storage controller.

FIG. 6 is a simplified block diagram of an embodiment of the present invention wherein the host performs the encryption.

FIG. 7 is a simplified block diagram of an embodiment of the present invention wherein the storage media has a hidden partition.

FIG. 8 is a simplified block diagram of an embodiment of the present invention wherein the encryption/decryption key is unlocked from and encrypted key using a root key.

### DETAILED DESCRIPTION OF THE PREFERRED EMBODIMENTS

The system and method of the present invention utilizes disc encryption as a method to enable safe disposal and/or repurposing of a storage device. For the purpose of this disclosure, the storage device may be fixed or removable, including hard disc drives, stand-alone storage media accessible via a network (wired or wireless), flash memory, tape media, or any other data storage media. Alternatively, the storage device may be a virtual storage system. The phrase “virtual storage system” refers to a defined set of locations or addresses where data can be stored. The locations or addresses may be distributed over portions of one or more storage devices in one or more servers or host systems, such that the virtual storage system appears to the user to be a local storage subsystem (such as a hard disc), but is actually a plurality of distributed memory locations.

According to an embodiment of the present invention, the encryption/decryption algorithm is executed by a controller of the storage media, such that the storage device provides its own security. For example, in a personal computer, the encryption/decryption algorithm is embedded in the controller firmware of the hard disc, and the controller encrypts/decrypts all data written to or read from the disc drive by the file system of the Operating system (hereinafter referred to as the “OS file system”), using an encryption key. Generally, the controller is understood to be contained within the storage device (or peripheral device). In the case of a virtual storage system, a virtual controller application may be required to effect the encryption algorithms.

In general, the present invention can be implemented in a variety of different ways and on different devices to encrypt data as it is written to the storage media. In one embodiment, the present invention utilizes a “secret” or private key stored in a non-volatile store to encrypt and to decrypt data written to and read from the storage media. As used herein, the term ‘secret’ refers to a string of information that is hidden or otherwise protected from exposure to users. A secret may be known to a file system, a controller or other device authorized to access protected information. Generally, a secret is concealed and utilized to validate data, to unlock a key, or in some instances may be used as a key to encrypt and to decrypt data. The key may be employed directly as a symmetric encrypting/decrypting key or indirectly as a key to unlock the actual encrypting/decrypting key. Upon removal or replacement of the key, the data is rendered unreadable.

In second embodiment, the secret is removed to a remote location. In this embodiment, the secret is loaded dynamically by the drive during times of desired use and is used to encrypt and to decrypt the data. In a third embodiment, the basic secret is removed to a remote location. During times of desired use or as needed, the basic secret is loaded from the remote location and cryptographically combined with a secret kept on the media in order to derive the necessary symmetric key. In another embodiment, a user may know a secret password, which is combined with a stored key to create the encrypting/decrypting key. Conceptually, this can be generalized to a plurality of secrets that are combined to derive the encrypting/decrypting key. If these secrets are stored in different places, all such places must be present for the drive to yield its data.

In a fourth embodiment, the secret is removable token attached to the storage controller. Replacement or removal of the token allows for immediate, safe re-purposing of the storage media. In this embodiment, a removable token may be a physical hard token such as a smart card, a universal serial bus (USB) dongle, and the like. Alternatively, the removable token may be a certificate-type token, or even a cryptographic envelope that can act as an electronic key distribution vehicle.

In a fifth embodiment, the secret is stored in the firmware of the storage media. In this embodiment, the secret may be encrypted with a key stored remotely and accessed during power up or at times of desired use.

While a number of embodiments are described in detail below, it will be understood by a worker skilled in the art that if data written to and read from the drive is encrypted, protection of the encryption/decryption key is tantamount to protection of the data. Thus, using techniques described herein, data stored on a computer can be protected during use, and those protections can remain in force even if the disc drive is stolen, resold or discarded.

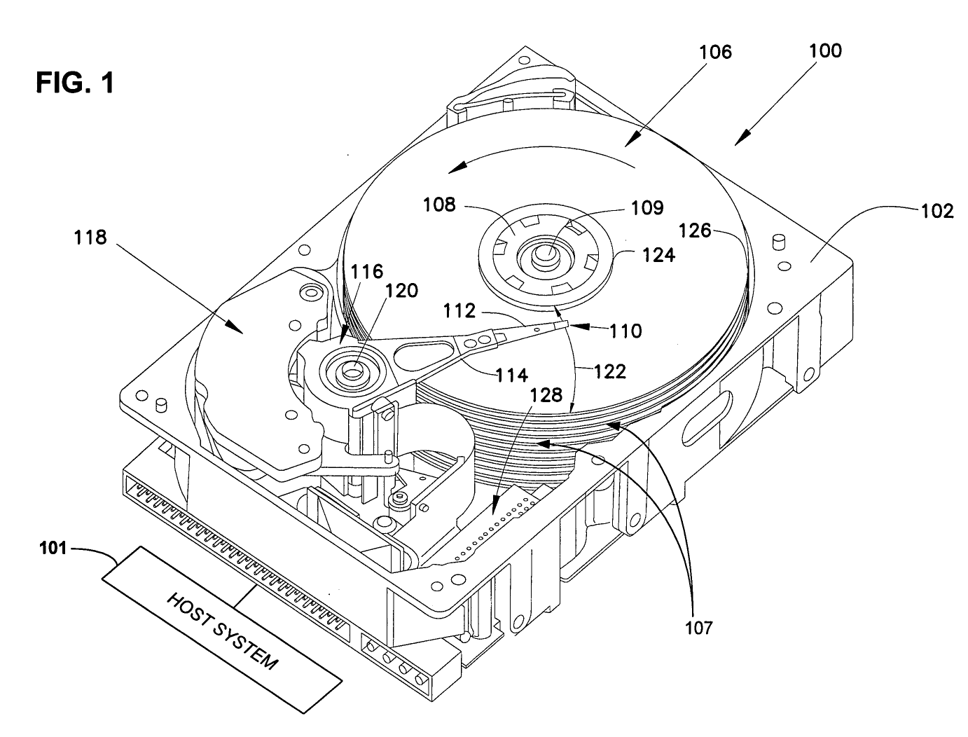

FIG. 1 is a perspective view of a disc drive 100 in which the present invention may be used. Disc drive 100 can be configured as a traditional magnetic disc drive, a magneto-optical disc drive or an optical disc drive, for example. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs 107, which are mounted for co-rotation about central axis 109. Each disc surface has an associated slider 110, which is mounted to disc drive 100 and carries a read/write head for communication with the disc surface.

In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached sliders 110 about a pivot shaft 120 to position sliders 110 over a desired data track along a path 122 between a disc inner diameter 124 and a disc outer diameter 126. Voice coil motor 118 operates under control of internal circuitry 128. Other types of actuators can also be used, such as linear actuators.

During operation, as discs 107 rotate, the discs drag air under the respective sliders 110 and along their bearing surfaces in a direction approximately parallel to the tangential velocity of the discs. As the air passes beneath the bearing surfaces, air compression along the air flow path causes the air pressure between the discs and the bearing surfaces to increase, which creates a hydrodynamic lifting force that counteracts the load force provided by suspensions 112 and causes the sliders 110 to lift and fly above or in close proximity to the disc surfaces.

In general, a host system 101 interacts with the disc drive 100 via the internal circuitry 128 of the disc drive 100. The circuitry 128 and associated firmware controls access to the storage media 107 and is sometimes referred to as a “controller” or a “controller interface”.

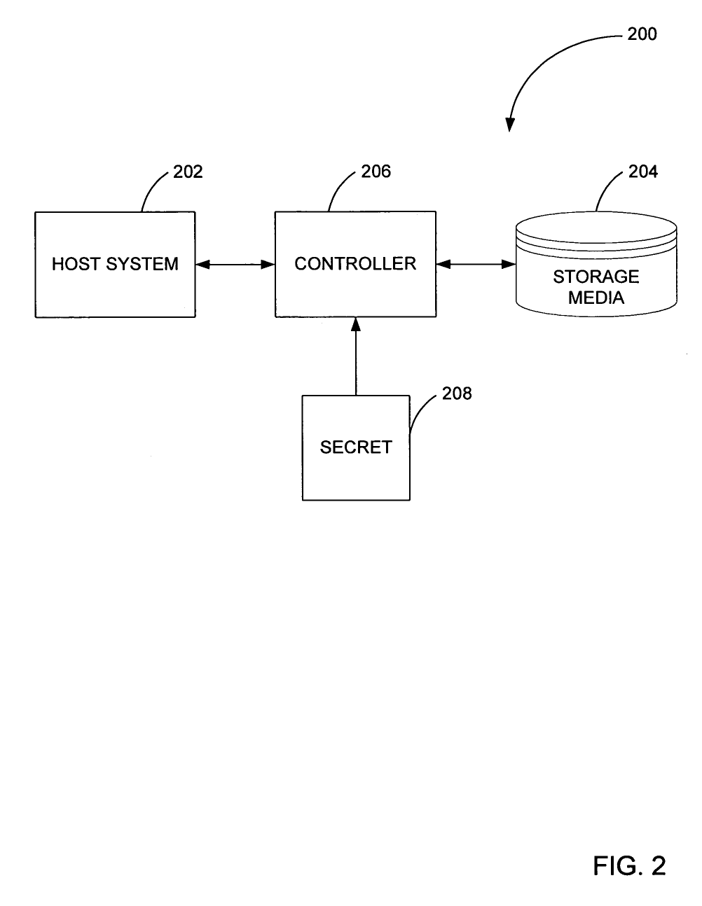

FIG. 2 is a block diagram of a disc encryption system 200 according to an embodiment of the present invention. The system 200 includes a host system 202 and a storage media 204, which communicate via a controller 206 using a secret 208.

The host system 202 may be any device that transfers data to and from a memory storage media 204 (fixed, removable, and/or virtual) via a controller 206. Generally, the host system 202 is a device that is connected to a private network and/or a public network, whether directly or indirectly. For example, the host system 202 may include, but is not limited to, desktop computer systems, laptop computer systems, networked computer systems, wireless systems such as cellular phones and PDA's, digital cameras including self-contained web-cams, and/or any reasonable combination of these systems and devices.

The storage media 204 may be a hard disc, a floppy diskette, a flash memory card, an external or removable storage device, a stand-alone storage device, or any other data storage media. In an alternative embodiment, the storage media 204 may be a virtual storage device, which is defined by one or more address locations adapted to store data from the host. The terms “storage device” and “disc drive” or “disc” are used interchangeably, except where otherwise noted. The term “storage media” refers to the media in the storage device on which the data is stored. Generally, the storage media 204 may include any device for storage of data in a system in accordance with the encryption methods and systems discussed herein. Notwithstanding the use of the term “disc”, the storage media need not necessarily incorporate a physical “disc”, but preferably incorporates a place for storage managed by a controller with firmware.

As used herein, the controller 206 refers to a device that controls the transfer of data between the host system 202 and a peripheral device, such as a disc drive. Typically, the controller 206 is a part of the peripheral device. In a personal computer, for example, the computer can be a host system 202, and the controller 206 refers to the circuitry and associated firmware within the disc drive that controls the transfer of data and commands between the host system 202 and the disc drive (storage media 206). Alternatively, the controller 206 may refer to the circuitry and associated firmware that controls the transfer of data and commands between the host system 202 and a floppy disc drive, a read/write CD ROM drive, a read/write DVD Drive, other removable memory media, or other storage devices. Typically, the controller 206 is designed to communicate with an expansion bus of the host system 202. The controller 206 controls read and write operations to and from the storage media 204. In one embodiment, the controller 206 may be conceptualized as an “encrypting controller”, since in the present invention, the controller is generally responsible for encrypting and decrypting all communications between OS file system of the host system 202 and the storage media 204.

In this embodiment, the secret 208 is held in a non-volatile store (not shown), such as a ROM memory, a non-writable firmware, EPROM, EEPROM, or the like. The term “non-volatile store” refers to any type of memory that does not lose its contents when its power is removed. Such non-volatile memory can be useful in microcomputer circuits because it can provide instructions for a Central Processing Unit (CPU) as soon as power is applied, and before secondary devices such as the disc drive can even be accessed. The secret 208 need only be as small as a few bytes long, but can be many bytes in length.

In an alternative embodiment, the secret 208 is stored in a separate, non-volatile storage device (not shown) that is connected directly to the drive electronics, such as by a serial port. In this embodiment, the drive electronics can load the secret 208 directly from the separate storage device on power up, as needed, or at times of desired use.

In general, the controller 206 utilizes the secret 208 to encrypt and to decrypt all data that is written to or read from the storage media 204 by the OS file system. A single key is used to encrypt the entire storage media 204. In this embodiment, the data on the storage media 204 becomes unreadable when the secret 208 is deleted or replaced.

In this embodiment, the secret 208 is employed directly as a symmetric encrypting/decrypting key for substantially all of the data that is written to or read from the magnetic storage by the OS file system. In another embodiment, the secret 208 can be utilized as a key to unlock the encrypting/decrypting key. In still another embodiment, the secret 208 may be combined with a password or another secret stored in a different location to form the encryption/decryption key.

Authorization to remove or change the secret 208 can be protected by employing various techniques. For example, authorization can be protected using an authority table stored in a hidden partition on the storage media such as that disclosed in copending application Ser. No. 09/912,931, which is incorporated herein by reference. In another embodiment, the secret 208 can be protected using a public key cryptographic system wherein the secret 208 itself is encrypted and can only be unlocked with a key acquired through an authentication process.

The symmetric encrypting algorithm may be based on a triple data encryption standard (triple DES in which Data is encrypted with a first key, decrypted with a second key, and finally encrypted again with a third key), an Advanced Encryption Standard (AES), or another standard suitable to the circumstances and to the disposal safety level required. In this embodiment, coding with tweaks, such as logical block numbers, may also be employed to enhance the inherent security of the chosen cipher.

It will be understood by a worker skilled in the art that if the controller 206 is configured to encrypt the data as it is written to the storage media 204 and if all the data written or read by the OS file system is encrypted, then protecting the secret 208 is the same as protecting the data. In other words, by protecting the key and by exercising appropriate key management techniques, the data can be kept secure even if the drive is removed.

It should be understood by a worker skilled in the art that whole disc encryption or whole partition encryption does not necessarily imply that the full contents of every instruction are encrypted to or decrypted from the storage device. In general, the payload of any read or write operation to the storage media is encrypted. However, certain commands may contain data that communicate control data to the controller. Such control data may need to be unencrypted. An example is a key retrieved from the drive that will become the encryption key for the drive. Similarly, a key, which is sent in a payload and which will become the encryption key for the drive, may need to be unencrypted.

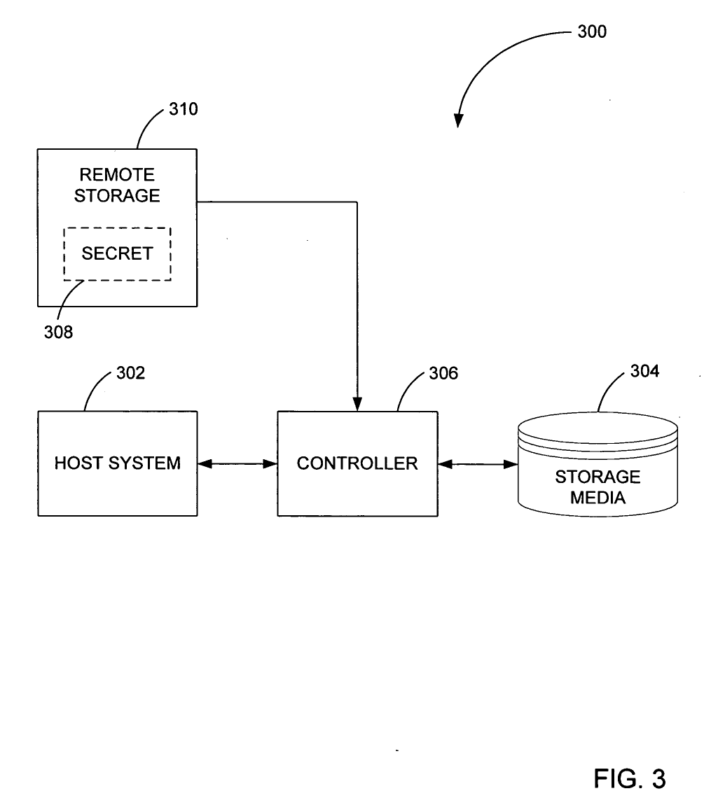

FIG. 3 is a block diagram of a disc encryption system 300 according to an embodiment of the present invention. The system 300 includes a host system 302 and a storage media 304, which communicate via a controller 306 using a secret 308 stored in a remote storage 310. In a preferred embodiment, the remote storage 310 employs security measures adapted to protect the secret 308 from unauthorized access. For example, the remote storage 310 may wrap the secret 308 in a cryptographic envelope before transmitting the secret 308 to the controller.

The remote storage 310 may be a server or any other system that is physically separate from the storage device. In one embodiment, the remote storage 310 is a server connected to the storage device via a network. In another embodiment, the remote storage 310 is a storage device that is directly connected to the storage media 304 via the controller 306. In a preferred embodiment, the remote storage 310 includes security features designed to prevent unauthorized disclosure of the stored secret 308.

When the system 300 is powered up, the secret 308 is loaded on the drive dynamically from the remote storage 310. Once the secret 308 is loaded, data stored on the storage media 304 is accessible to the host system 302 via the controller 306, which encrypts and decrypts the data using the secret 308. It will be understood by a worker skilled in the art that to permit network use of passing keys and/or retrieval of a key or secret from a remote location, some data stored on the storage device (such as in a boot block) will not be encrypted. Specifically, the storage device must have access to sufficient information that it can communicate and respond with the remote storage 310.

In this embodiment, the secret 308 is removed from the controller 306 when the storage device is powered down or placed into a sleep mode. When the storage device is powered up, the controller 306 requests the secret 308 from the remote storage 310. Depending on the implementation, the secret 308 may be provided. Alternatively, the remote storage 310 may require a correct user password (or a correct physical or electronic token) before granting the secret 308 to the requesting controller 306.

If the storage device is removed from the host system or moved from the network to which it is attached, the controller 306 cannot access the remote storage 310 to load the secret 308 on startup, and the data stored in the data storage 304 becomes inaccessible. Alternatively, if a user or device attempts to access the stored data without the correct password or token, the remote storage 310 will refuse to grant the secret 308, and the data remains secure.

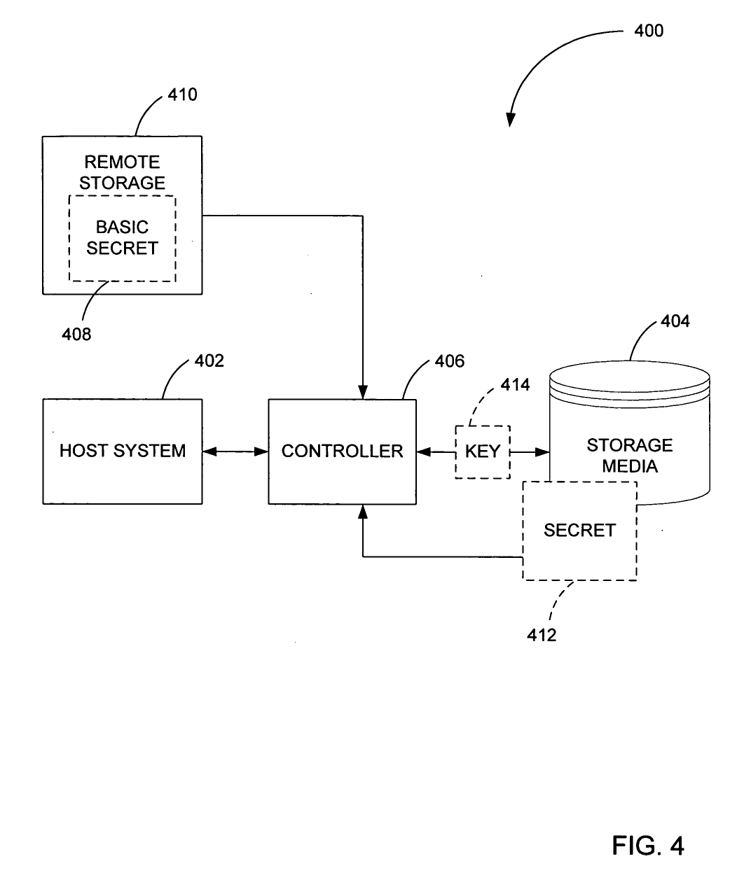

FIG. 4 is a block diagram of a disc encryption system 400 according to another embodiment of the present invention. The system 400 includes a host system 402 and a storage media 404, which communicate via a controller 406. In this embodiment, the controller 406 encrypts and decrypts data using a key 414 formed by cryptographically combining a basic secret 408 stored on a remote storage 410 and a secret 412 stored locally. The secret 412 is illustrated in phantom to indicate that it may be stored on the storage media 404, in another non-volatile memory location, in another storage device, or in the controller firmware.

While FIG. 4 illustrates a key 414 formed from a combination of the basic secret 408 and the secret 412, the key 414 may be formed from a plurality of secrets that are combined to derive the encryption/decryption key 414. Additionally, as discussed above, the remote storage 410 (or even the controller itself) may require a password or other authentication device, which may be used to retrieve the required secrets (408 and 412) or which may be combined with the secrets 408 and 412 to form the encryption/decryption key.

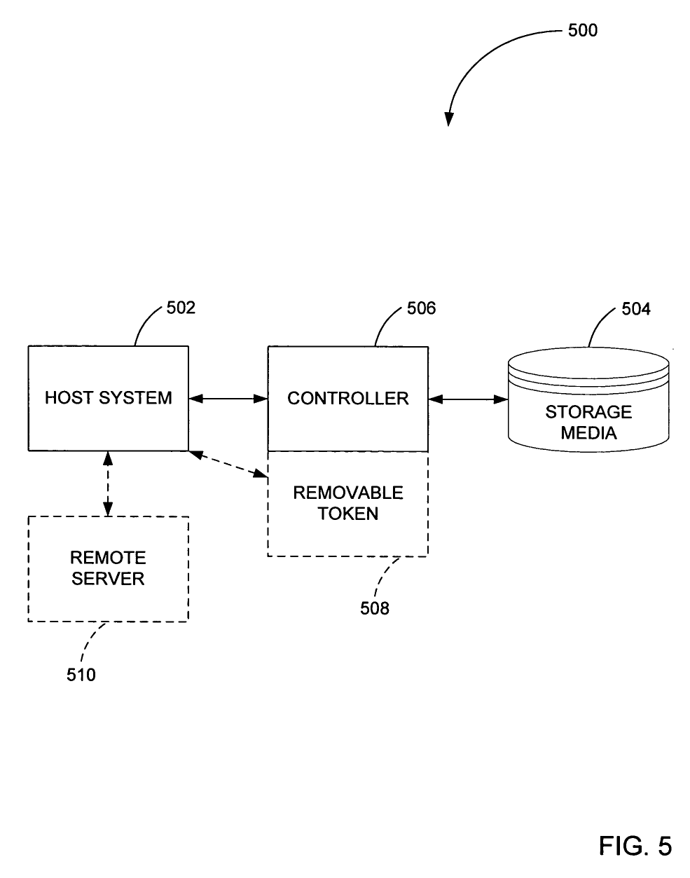

FIG. 5 is a block diagram of a disc encryption system 500 according to an embodiment of the present invention. The system 500 includes a host system 502 and a storage media 504, which communicate via a controller 506 using a removable token 508 attached to the controller 506.

In one embodiment, the removable token 508 is a physical hard token, such as a smart card, a USB dongle, and the like. A USB dongle is small device that is supplied with software and that plugs into a USB port. Typically, the software of the USB dongle integrates with a port of the storage device during execution in order to verify its physical presence. If the USB dongle is not present, the software won't work. In this embodiment, the USB dongle is a hardware key that is used to unlock the drive. Other physical tokens may also be used.

In this embodiment, the physical token 508 is required to access the encrypted data stored on the storage media 504. If the storage device is stolen, the data remains inaccessible unless the physical token 508 is also stolen.

In another embodiment, the removable token 508 is a certificate-type token (such as an ISO X.509v3 certificate). For example, the token may be a digital certificate, which serves as a credential where a third-party authority certifies that the requesting entity can be trusted. In this embodiment, the data is “transmitted” from the host 502 to the storage media 504 via the controller 506.

In general, absent a certificate-type removable token 508, the data on the storage media 504 is inaccessible. If an identifier or other element of the certificate-type token 508 is combined with a secret or with other data stored separately from the storage media 504, not only the token 508 but other secrets must be available on power-up and combined to form the encryption/decryption key in order to unlock the data.

In FIG. 5, the remote server 510 is shown in phantom because it may not be necessary for all implementations of the removable token. For example, if the removable token 508 is a USB dongle or an attached serial device, the remote server 510 may be superfluous. However, where the removable token 508 is a digital signature or certificate, the remote server 510 may be required as a certificate authority. In some instances, such as when the removable token is a secure ID card (meaning that the card provides an identifier number that changes periodically), the controller 506 may verify the entered secure ID number with an authority table in the remote server 510.

In this embodiment, if the token 508 is a certificate-type token that is verified by the remote server 510, replacement of the removable token 508 with a different certificate-type token in an authority table of the remote server 510 allows for immediate, safe repurposing of the storage media 504. The remote server 510 can be authorized and configured to maintain an authority table in order to control access to the data stored on the storage media 504.

In an alternative embodiment, access permissions associated with the removable token 508 and stored in an authority table (either on the storage media 504 or on the remote server 510) may be deleted or revoked, allowing for immediate, safe re-purposing of the storage media 504. The remote server 510 can be authorized and configured to delete (remove or revoke) the access permissions associated with the token 508 in order to render the data stored on the storage media 504 unusable (inaccessible) using that particular token 508.

This embodiment may be particularly useful for high security environments in which the network is secured after normal working hours. For example, at 6:00 pm each day, access permissions for the removable token 508 can be removed or replaced so as to render the encrypted data stored on the device unusable. The access permissions for the removable token 508 could then be restored, for example, at a pre-determined time or when the user logs back into the system 500. This technique can be used to secure storage devices during non-standard working hours.

In an alternative embodiment, the storage media 504 may be partitioned and each partition may be associated with a particular user or use. The disc controller may be made aware of these partitions by through an access-controlled table that it hides on behalf of a partition manager. In this embodiment, each partition may be encrypted with a different secret or key that is associated with the particular user or use. When a user (or a device) logs in, via a success authentication process, a removable token associated with the user or with the use can be provided to the controller by an authentication server (such as remote server 510) for unlocking the portion of the storage media associated with that user or that use. In this manner, people from different shifts at a company could use the same computer while maintaining the integrity of each user's data. Alternatively, an authorized system may have access to a particular partition for a particular use.

In this embodiment, authentication is a process of determining the identity of a user, a device, or an information source attempting to access the storage device. For example, access to each partition can be restricted such that only an authorized user can access a partition, and a device may be authenticated to access such a partition. Typically, the process of authentication involves establishing, such as by challenge and response, that a transmission attempt is authorized and valid; that a user, a device, or information source is who or what he/she or it claims to be; or that data (that has been stored, transmitted or otherwise exposed to possible unauthorized modification) remains uncompromised (meaning that the data's integrity has been maintained).

An authentication server is simply a phrase used to describe a networked or other secured device or device component such as a trusted drive or a trusted execution environment processor that performs authentication processes with respect to the storage subsystem. In one embodiment, authentication and authorization may be handled by a trusted drive feature within the drive. In an other embodiment, the authentication may be handled by an authentication server or device (such as remote server 510, while authorization may be controlled by encrypted authority tables stored in a hidden partition on the disc drive.

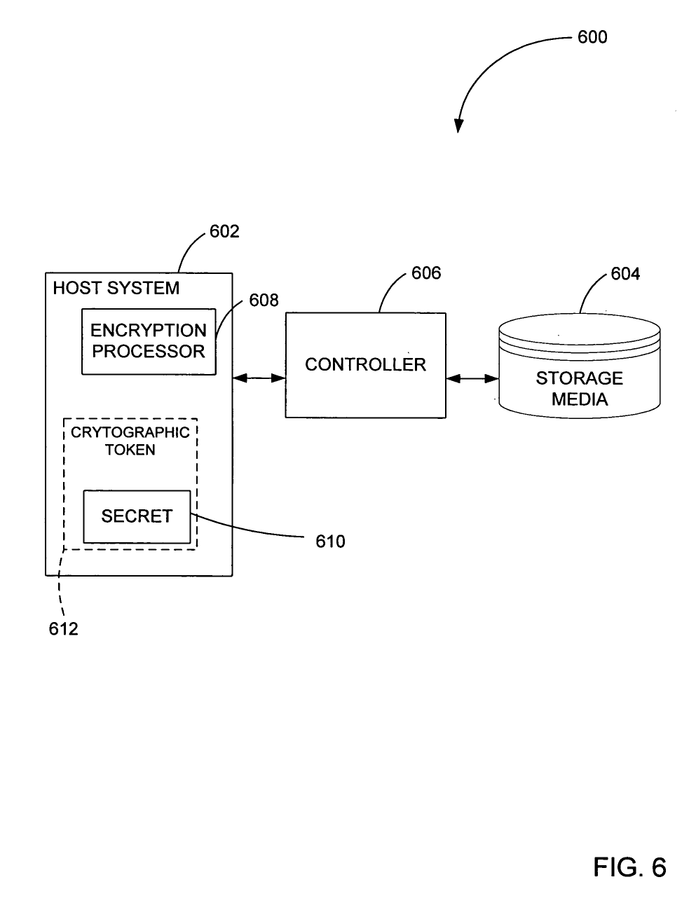

FIG. 6 is a block diagram of a disc encryption system 600 according to an embodiment of the present invention. The system 600 includes a host system 602 and a storage media 604, which communicate via a controller 606. In this embodiment, the encryption is performed by the host system 602, rather than the controller 606. The host system 602 encrypts and decrypts all of the data written to or read from the storage media 604 by the OS file system. A secret 610 is stored at the host system 602 and may be protected using a cryptographic token 612.

The encryption processor 608 may be software, hardware or a combination of software and hardware, depending on the specific implementation. In an alternative embodiment, a secret 610 and a basic secret may be stored in different locations and combined to form a key that is used by the encryption processor 610 to encrypt and decrypt data written to and read from the storage media 604.

In general, the present invention uses “whole” disc encryption where there is a single encryption/decryption key for each disc or for each partition on the disc. When whole disc encryption is provided with a single encryption/decryption key, the task of securing or repurposing the storage device is extremely convenient and nearly instantaneous. By simply removing the encryption/decryption key from the encryption machinery, the storage device is secured. Furthermore, well-known encryption algorithms, such as three-DES and AES, ensure that without the key the data cannot be read.

Whole disc encryption has the additional advantage of providing a tamper evident environment. Since the files and the file structure strongly resist exposure, the attacker is left having to delete the entire disc, which exposes a malicious action and opens the attacker to discovery.

While the present invention has been largely discussed with respect to whole disc encryption, it may also apply to whole partition encryption, or whole volume encryption that may span many disc drives. Additionally, the present invention may be applied to solid state storage or other types of non-volatile storage. The present invention may also be applied to volatile storage devices that require constant power to maintain data.

An appropriate model for securing the whole disc is to regard the encryption/decryption key as the entirety of the data. In a preferred embodiment, this key is a three-DES key or an AES 128-bit (16-byte) key. The protection and management of the key is equivalent to the protection and management of the data on the entire storage volume.

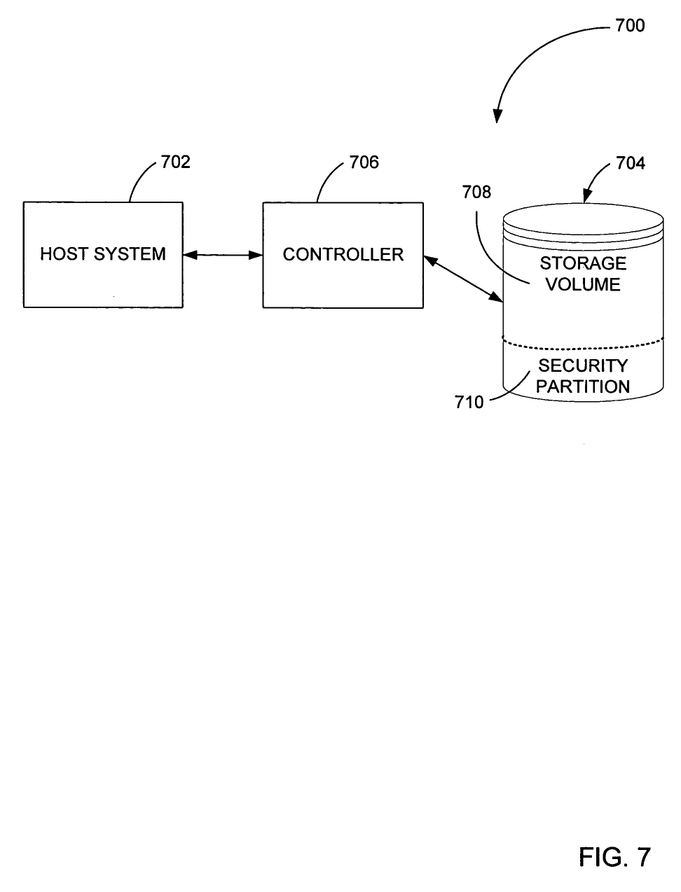

FIG. 7 illustrates another embodiment of the present invention using a hidden partition. As shown, the storage system 700 has a host system 702, which communicates with a storage media 704 via a controller 706. As shown, the storage media 704 is partitioned into a storage volume 708 and a hidden partition or security partition 710. In this embodiment, the communication between the host system 702 and the storage media 704 is encrypted using a key that is stored in the security partition 710

The hidden security partition 710 is hidden at the level of the low-level formatting on the drive and can be protected from whole volume encryption because no user command can write (or read) this space. Exactly one security partition 710 may be utilized to manage one or more keys for one or more storage volumes. Data in the security partition 710, including the one or more keys, optionally can be encrypted using a different key.

In a preferred embodiment, the encryption machinery is in the drive electronics. The encryption machinery has access to the encryption key during encryption and decryption. Suitable electronics blinding techniques can be utilized to reduce the possibility of direct electromagnetic discovery of the key. Additionally, the encryption machinery may be protected with a physical tamper evident wrapping or other technique that may readily reveal if a key may have been exposed by a physical attack.

In general, the key may be stored in one or more of five basic places: in a non-volatile solid state storage security partition in the drive electronics, in a security partition on the storage media, in a secure container in the host system, in a secure host system or another security partition in another host system on a network, or in a separate non-volatile storage device security partition directly connected to the drive electronics such as by a serial port.

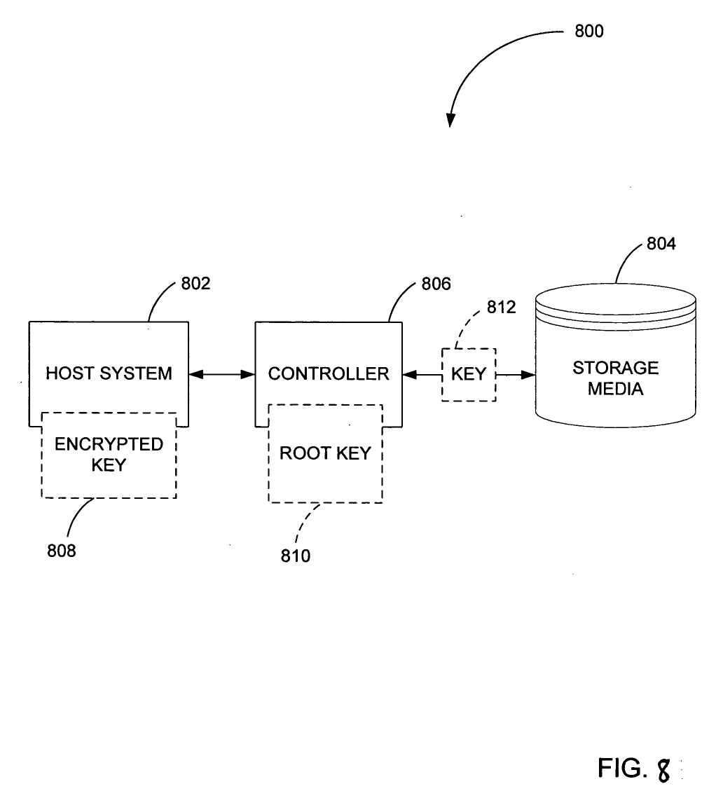

FIG. 8 illustrates an embodiment of the present invention using a root key to unlock the encryption/decryption key in the drive electronics. As shown, the system 800 has a host 802, which communicates with the storage media 804 via a controller 806. An encrypted key 808 is provided in any one of the storage locations described above. The encrypted key 808 is shown in phantom to indicate that the storage location may vary. A second key (root key) 810 is provided in the drive electronics. The root key 810 cannot encrypt or decrypt data from the drive, but is employed by the controller 806 to encrypt and to decrypt the encrypted key 808 in order to derive the encryption/decryption key 812 for accessing the data. In a preferred embodiment, the encryption machinery in the drive electronics is the only location where the key is known in plaintext (human readable form), meaning that the key is generally not viewable by a user except in an encrypted form.

In one embodiment, the root key is produced by permanent fusing. In another embodiment, the root key is generated randomly by the manufacturer. Alternatively, other techniques for producing the root key may be used. Since the root key 810 unlocks the encrypted key 808, the key 808 can be stored in any number of the above-identified locations without fear of exposure.

To secure the volume, it is necessary to remove the encrypted key 808 and the encryption/decryption key 812 from the drive electronics. Removing the encrypted key 808 may be as simple as replacing the encrypted key 808 with the encryption/decryption key 812, since the encryption/decryption key 812 is recovered using the hidden root key 810. However, all locations where the encrypted key 808 exists must be examined, and the encrypted key 808 must be denied to the drive electronics. In the case of permanent disc disposal, all copies of the encrypted key 808 are deleted. If the encrypted keys 808 are stored in a security partition, these can be easily determined. In a preferred embodiment, the key 812 is generated as a random number in the drive electronics and read out only as an encrypted key 808.

If a user desires to use the same key over a plurality of devices, then the user can utilize a secure partition (such as that discussed in FIG. 7) to provide such key management. In a preferred embodiment, the user may want to make use of security partitions on a host system other than the machine in order to do this key management. If the drive electronics do not support a hardware protected root key for encrypting and decrypting the key, then a security partition may be provided and configured on the drive with a root key, which cannot be read. The encrypted key may then be stored on the security partition or in any of the other locations previously discussed. While physical attack is easier in this instance, tamper evident packaging may again mitigate the risk.

Security partitions may be used to provide a method for tracking all copies of the encrypted key. In a preferred embodiment, this is done with public key cryptography. In this case, the security partition keeps a list of all public keys of all authorities permitted to read the encrypted key or to write the encrypted key. Each authority must cryptographically prove that it is requesting to read or write the encrypted key using well-known signing and verification techniques. The encrypted key may then be securely sent to the target security partition using well-known public key encryption and decryption techniques. Each security partition can have a table of all security partitions permitted to hold the encrypted key, and thereby maintain a means of tracking down all copies of the encrypted key for deletion and removal. More generally, this same table may hold different encrypted keys for various different volumes, and thereby permit redundancy while assuring that all encrypted keys can be tracked and eliminated or held in abeyance as specified by host system commands.

A security partition on a target volume may also have this table. In such a case, it may be sufficient to delete the security partition with the encrypted key. By deleting the security partition, the encrypted key cannot later be written back to the security partition from a copy stored in another security partition.

In another embodiment, since a goal of the present invention is to physically eliminate the encrypted key from the target volume security partition, a globally unique identifier may be used which may be used to encrypt the key. A list of valid identifiers on the target security partition can be examined to determine if a key has been permanently disposed of, and thereby deny writing of a copy of the voided encrypted key to the target security partition. This technique provides a positive feature that it would be possible with the right knowledge of the electronics and the right equipment to bypass this protection and re-insert an encrypted key that had previously been made invalid. If a user does not desire this feature, then the user must take active steps to be certain that all copies of the encrypted key have been destroyed. To do this, the user would make use of the security partitions to maintain a record of where all encrypted keys are stored.

The root key technique provides a convenient and effective mechanism for masking the private key, and optionally for associating it with an index to the key. However, the root key does not ensure that security partitions cannot be impersonated and thereby provide a means by which an encrypted key copy can be kept by an impersonator.

In a preferred embodiment, the whole disc may have a public/private keychain (the signing and exchange key pair on the administrative security partition) with certificates signed by the drive manufacturer that can attest to the fact that the volume contains legitimate security partitions. In a preferred embodiment, no table entry for an encrypted key can contain a public verification and exchange key unless those keys are proven to be associated with legitimate manufacturer security partitions. The root key on a drive can additionally be employed to encrypt the private keys of these key pairs and thereby deny their use off the disc or storage media. However, this technique makes sense only if the root key is hidden in the drive electronics.

FIG. 9 illustrates a simplified block diagram of the root key process. As shown, an encrypted key 900 is processed with a root key 902 to produce a plaintext key 904 for encrypting and decrypting data written to or read from a storage media. The plaintext key 904 is again processed with the root key 902 to produce the encrypted key 900, which can be read out. In this embodiment, the key 904 can encrypt/decrypt data, but cannot be read, while the encrypted key 900 can be read but cannot encrypt/decrypt data stored on the drive.

Using security partitions, an administrative security partition can use a signing and exchange keypair on the administrative Security Partition with certificates signed by the drive manufacturer. In this embodiment, the encrypted key may be stored in a table, such that if an encrypted key is voided, it is also erased from the table.

Table 1 (below) is a simple table of encrypted keys, such as may be stored in a security partition.

| | | Sign | Exchange | | |
|---|---|---|---|---|---|
| Identifier | Ke | Cert | Cert | State | Master |
| 24 Bytes | 16 Bytes | 4096 | 4096 | Valid/Voided | Yes/No |
| | | Bytes | Bytes | | |

As shown, the table may include an identifier, an encrypted key, a signing certificate, an exchange certificate, a current state, and a master indicator. If the encrypted key is voided, it is also erased from the table, though the identifier remains. In a preferred embodiment, the public keys are also erased, though they need not be.

In another embodiment, the, table is extended to mark the master copy of the encrypted key. The drive firmware can then reinforce the security measures by preventing copying of the encrypted key, unless it is made from the master. In this manner, copies can only be made of the master, and may only be deleted by the master. This technique provides a simple means for tracking all copies of the encrypted key and of assuring that all tables are current and synchronized.

Although the present invention has been described with reference to preferred embodiments, workers skilled in the art will recognize that changes may be made in form and detail without departing from the spirit and scope of the invention.

1. A storage system with integrated information security features adapted to interact with a host system, the storage system comprising:
a storage media adapted to store data;
a controller adapted to control data transfers between the host system and the storage media, the controller adapted to encrypt and decrypt data written to or read from the storage media using an encryption key based on a secret.

2. The method of claim 1 wherein the storage system comprises a disc drive.

3. The system of claim 1 wherein the controller uses the encryption key indirectly to encrypt and decrypt data, the system further comprising:
a basic secret;
wherein the controller is adapted to retrieve the basic secret and to combine the basic secret and the secret to produce the encryption key.

4. The system of claim 1 wherein the encryption key comprises a secret, the system further comprising:
a network adapted to issue the secret in a cryptographic envelope according to predetermined parameters.

5. The system of claim 1 wherein the encryption key is derived from a removable token.

6. The system of claim 5 wherein data stored on a portion of the storage media is inaccessible when the removable token is revoked.

7. The system of claim 1 and further comprising:
an authority table defined in a hidden partition on the storage media, the authority table adapted to maintain a list of one or more users or user agents authorized to change the encryption key.

8. A storage device adapted to provide integrated encryption security, the storage device comprising:
a storage media adapted to store data received from a host system; and
a controller within the storage device adapted to control data transfers between the host system and the storage media, the controller adapted to encrypt and decrypt data written to or read from the storage media via a removable token.

9. The storage device of claim 8 wherein the storage device comprises a disc drive.

10. The storage device of claim 8 wherein the removable token comprises:
a physical device token attached to the storage device during use; and
wherein removal of the physical device token renders the storage device inaccessible.

11. The storage device of claim 10 wherein the removable token is a smart card or a USB dongle.

12. The storage device of claim 8 wherein the removable token comprises:
a certificate-type token provided to the storage device by a requesting device, the certificate-type token serves as a credential; and
wherein the certificate-type token is required to access data stored on the storage device.

13. The storage device of claim 12 wherein the credential of the certificate-type token corresponds to an authority record stored in a hidden partition on the storage device.

14. The storage device of claim 12, and further comprising:
a certificate authority in communication with a requesting device, the certificate authority adapted to maintain one or more certificate-type tokens securely and to distribute a certificate-type token upon authentication to each authenticated device.

15. The storage device of claim 8 and further comprising:
a second storage device adapted to connect to a port of the storage device during use;
wherein the second storage device acts as a physical key to unlock data stored on the storage device.

16. A method for securing data on a storage device having a controller and a storage media, the method comprising:
configuring the controller to encrypt data written to the storage media with a symmetric key; and
wherein the symmetric key is known in plaintext to the controller.

17. The method of claim 16 and further comprising:
configuring the controller to decrypt with the symmetric key all data read from the storage media.

18. The method of claim 16 and further comprising:
dynamically loading an encrypted secret from a remote location upon powering on the storage device; and
deriving the symmetric key from the encrypted secret using a secret stored within the storage device.

19. The method of claim 16 wherein the symmetric key comprises a removable token attached to the controller.

20. The method of claim 16 and further comprising:
combining a basic secret stored at a remote location with a secret stored in the storage device to form the symmetric key.

21. The method of claim 16 wherein at least a portion of the symmetric key is stored in a predetermined location, the method further comprising:
deleting the portion of the symmetric key from the predetermined location in order to render inaccessible all the data stored on the storage media.

22. The method of claim 16 wherein at least a portion of the symmetric key is stored in a predetermined location, the method further comprising:
removing the portion of the symmetric key from the predetermined location at predetermined intervals in order to render inaccessible all the data stored on the storage media; and
restoring the portion of the symmetric key from a key store upon authentication of an authorized user.

23. The method of claim 16 wherein the symmetric key comprises:
an encrypted key stored in a remote location and loaded at times of desired use;
a root key stored in the storage device; and
wherein the root key unlocks the encrypted key to derive the symmetric key.

24. A storage system comprising:
a storage media;
a data interface element disposed adjacent to the storage media; and
a controller which interacts with the data interface element to read or write data between the storage media and a host system using an encryption key based on a secret.

25. The storage system of claim 24 wherein the storage system comprises a disc drive.

26. The storage system of claim 24 and further comprising:
controller firmware coupled to the controller;
wherein the secret is stored in the controller firmware.

27. The storage system of claim 24 wherein the controller encrypts data written to and decrypts data read from the storage media using the encryption key.

28. The storage system of claim 27 and further comprising:
a basic secret;
wherein the encryption key comprises a combination of the basic secret and the secret.

29. A storage device comprising:
a storage media;
a data interface element disposed adjacent to the storage media; and
a controller which interacts with the data interface element to read or write data between the storage media and a host system using an encryption key based on a removable token.

30. The storage device of claim 29 wherein the removable token comprises a physical token attached to the storage device during operation.

31. The storage device of claim 29 wherein the removable token comprises a smart card or a USB dongle.

32. The storage device of claim 29 wherein the removable token comprises a certificate-type token provided to the storage device by the host system.

33. The storage device of claim 29 wherein the removable token comprises a second storage device coupled to a port of the storage device during operation.

34. The storage device of claim 29 wherein the storage device comprises a disc drive.

35. A storage device comprising:
a storage media;
a data interface element coupled to the storage media; and
a controller coupled to the data interface element, the controller interacting with the data interface element to read or write data between the storage media and a host system using an encryption key.

36. The storage device of claim 35 wherein the storage device comprises a disc drive.

37. The storage device of claim 35 wherein the encryption key is derived from a secret.

38. The storage device of claim 35 wherein the encryption key is based on a removable token.
